(19) United States
(12) Patent Application Publication
(10) Pub. No.: US 2022/0080816 A1
(43) Pub. Date: Mar. 17, 2022

(54) GLASS RUN

(71) Applicant: TOYODA GOSEI CO., LTD., Kiyosu-shi (JP)

(72) Inventors: Yuichi Hishida, Kiyosu-shi (JP); Tomohiro Takase, Kiyosu-shi (JP)

(21) Appl. No.: 17/399,124

(22) Filed: Aug. 11, 2021

(30) Foreign Application Priority Data
Sep. 15, 2020 (JP) 2020-154366

(51) Int. Cl. B60J 10/74; B60J 10/32; B60J 5/04

(52) U.S. Cl. CPC B60J 10/74; B60J 5/0402; B60J 10/32

(57) ABSTRACT

The glass run includes: a trim portion attached to a flange portion of a door frame and formed in a substantially U-shaped cross section from a glass run-side side wall, a body-side side wall, and a bottom wall connecting the glass run-side side wall and the body-side side wall; and a glass run portion integrally formed with the trim portion and sealing a space between the glass run portion and a door glass. In the trim portion, an insert including a plurality of strip-like skeletal pieces made of metal and arranged in substantially parallel to each other and connecting portions connecting the skeletal pieces is embedded. The connecting portions of the insert are embedded in either one of the glass run-side side wall and the body-side side wall of the trim portion.

### CROSS REFERENCE TO RELATED APPLICATION

This application claims the priority benefit of Japanese Patent Application No. 2020-154366 filed on Sep. 15, 2020. The entirely of the above-mentioned patent application is hereby incorporated by reference herein and made a part of this application.

### BACKGROUND OF THE INVENTION

### (1) Field of the Invention

The present invention relates to a glass run attached to a flange portion of a door frame of a door of an automobile.

### (2) Description of Related Art

Regarding a glass run attached to a flange portion of a door frame of a door of an automobile, for example, JP 2006-507174 A discloses the following technique. As illustrated in FIGS. 1 and 7, a glass run 100 of JP 2006-507174 A includes a trim portion 200 having a substantially U-shaped cross section and attached to a flange portion 301a of a door frame 301 of a door 201, and a glass run portion 300 in which an outer seal lip 330 and an inner seal lip 340 that are asymmetric are formed to seal a space between the glass run portion and a door glass 501.

An insert 400 (referred to as a carrier in JP 2006-507174 A), which is a metal reinforcing member for enhancing a holding force with respect to the flange portion 301a of the door frame 301, is embedded in the trim portion 200.

As illustrated in FIG. 8A, the insert 400 is provided with long slits 410 and short slits 420 formed by punching a rectangular band-shaped metal plate. Each of the long slits 410 has a same length, and each of the short slits 420 has a same length. In addition, the long slits 410 and the short slits 420 are arranged so as to leave a region B where the long slits 410 and the short slits 420 are not provided, shifted from a center line 430.

As shown in FIG. 8B, the insert 400 is bent into a channel shape. At this time, the long slits 410 extend into a channel-shaped base portion 440, but extend only partway through the base portion 440 (not beyond a half of the base portion 440). On the other hand, the short slits 420 do not extend at all to the channel-shaped base portion 440. In FIG. 8B, the short slits 420 each extend to approximately half of its side wall 450 of the channel shape.

The effect of JP 2006-507174 A describes that since the insert 400 has an asymmetric structure, the trim portion 200 of the glass run 100 in which the insert 400 is embedded can be relatively easily bent in a longitudinal direction in accordance with the curved door frame 301 corresponding to an upper side of the door 201, and its curved shape can be held.

### SUMMARY OF THE INVENTION

However, in the technique of JP 2006-507174 A, in the insert 400, connecting portions 470 that connect skeletal pieces 460 formed by the long slits 410 and the short slits 420 are formed to the side wall 450 at an upper portion of a vehicle from the base portion 440 (FIGS. 8A and 8B). As a result, particularly at the base portion 440, when bending into a shape along the curved door frame 301 corresponding to the upper side of the door 201, there are two axes of extension and contraction, so that a problem of difficulty in bending still remains.

Therefore, an object of the present invention is to provide a glass run in which a trim portion can be easily bent into a shape of a curved door frame corresponding to an upper side of a door of an automobile.

In order to solve the above problem, the present invention according to claim 1 is a glass run attached to a door frame of a door of an automobile and sealing a space between the door frame and a door glass, the glass run including a trim portion attached to a flange portion formed at a distal end of the door frame and a glass run portion integrally formed with the trim portion and sealing a space between the glass run portion and the door glass, in which the trim portion is formed in a substantially U-shaped cross section from a glass run-side side wall, a body-side side wall, and a trim portion bottom wall connecting the glass run-side side wall and the body-side side wall, an insert including a plurality of strip-like skeletal pieces arranged in substantially parallel to each other and connecting portions connecting the skeletal pieces is embedded in the trim portion, and the connecting portions of the insert are embedded in either one of the glass run-side side wall and the body-side side wall of the trim portion.

In the present invention according to claim 1, the glass run is formed by the trim portion attached to the flange portion formed at the distal end of the door frame, and the glass run portion integrally formed with the trim portion and sealing a space between the glass run portion and the door glass, in which the trim portion is formed in the substantially U-shaped cross section from the glass run-side side wall, the body-side side wall, and the trim portion bottom wall connecting the glass run-side side wall and the body-side side wall, the insert including the plurality of strip-like skeletal pieces arranged in substantially parallel to each other and the connecting portions connecting the skeletal pieces is embedded in the trim portion, and the connecting portions of the insert are embedded in either one of the glass run-side side wall and the body-side side wall of the trim portion. That is, the connecting portions of the insert are not embedded in the trim portion bottom wall.

As a result, by bringing the connecting portions closer to either one of an inside of the glass run-side side wall and an inside of the body-side side wall, the connecting portions serve as a neutral axis, and the body-side side wall or the glass run-side side wall in which the connecting portions are not formed on an opposite side across the flange portion of the door frame extends or contracts, so that it is possible to cause the trim portion to follow a shape of a vehicle door roof without special bending modification to the trim portion.

The present invention of claim 2 is, according to the invention of claim 1, the glass run in which the connecting portion of the insert is embedded in the glass run-side side wall. In the present invention of claim 2, since the connecting portion of the insert is embedded in the glass run-side side wall, a length of the connecting portion to be curved is shorter than that when the insert is embedded in the body-side side wall. As a result, since the body-side side wall where the connecting portion is not formed on the opposite side across the flange portion of the door frame extends, followability to the shape of the vehicle door roof is further improved.

A glass run is formed by a trim portion attached to a flange portion formed at a distal end of a door frame, and a glass run portion integrally formed with the trim portion, attached to an inner periphery of the door frame, and sealing a space between the glass run portion and a door glass, in which the trim portion is formed in a substantially U-shape in cross section from a glass run-side side wall, a body-side side wall, and a trim portion bottom wall connecting the glass run-side side wall and the body-side side wall to each other, an insert including a plurality of strip-like skeletal pieces made of metal and arranged in substantially parallel to each other and connecting portions connecting the skeletal pieces is embedded in the trim portion, and the connecting portions of the insert are embedded in either one of the glass run-side side wall and the body-side side wall of the trim portion. That is, the connecting portions of the insert are not embedded in the trim portion bottom wall.

As a result, by bringing the connecting portions closer to either one of an inside of the glass run-side side wall and an inside of the body-side side wall, the connecting portions serve as a neutral axis, and the body-side side wall or the glass run-side side wall in which the connecting portions are not formed on an opposite side across the flange portion of the door frame extends or contracts, so that it is possible to cause the trim portion to follow a shape of a vehicle door roof without special bending modification to the trim portion.

### BRIEF DESCRIPTION OF THE DRAWINGS

FIG. 1 is a side view of an automobile;

FIG. 2 is a cross-sectional view of a glass run according to a first embodiment of the present invention, and is a cross-sectional view corresponding to line A-A in FIG. 1;

FIG. 3 is an enlarged plan view of an insert according to the first embodiment of the present invention before bending;

FIG. 4 is a cross-sectional view of the insert according to the first embodiment of the present invention after bending;

FIG. 5 is a cross-sectional view of the glass run according to a second embodiment of the present invention, taken along line A-A in FIG. 1;

FIG. 6 is a cross-sectional view of the insert according to the second embodiment of the present invention after bending;

FIG. 7 is a cross-sectional view of a conventional glass run (JP 2006-507174 A); and

FIG. 8A is an enlarged plan view of an insert to be embedded in FIG. 7 before bending, and FIG. 8B is a perspective view of the insert to be embedded in FIG. 7 after bending (JP 2006-507174 A).

### DETAILED DESCRIPTION OF PREFERRED EMBODIMENTS

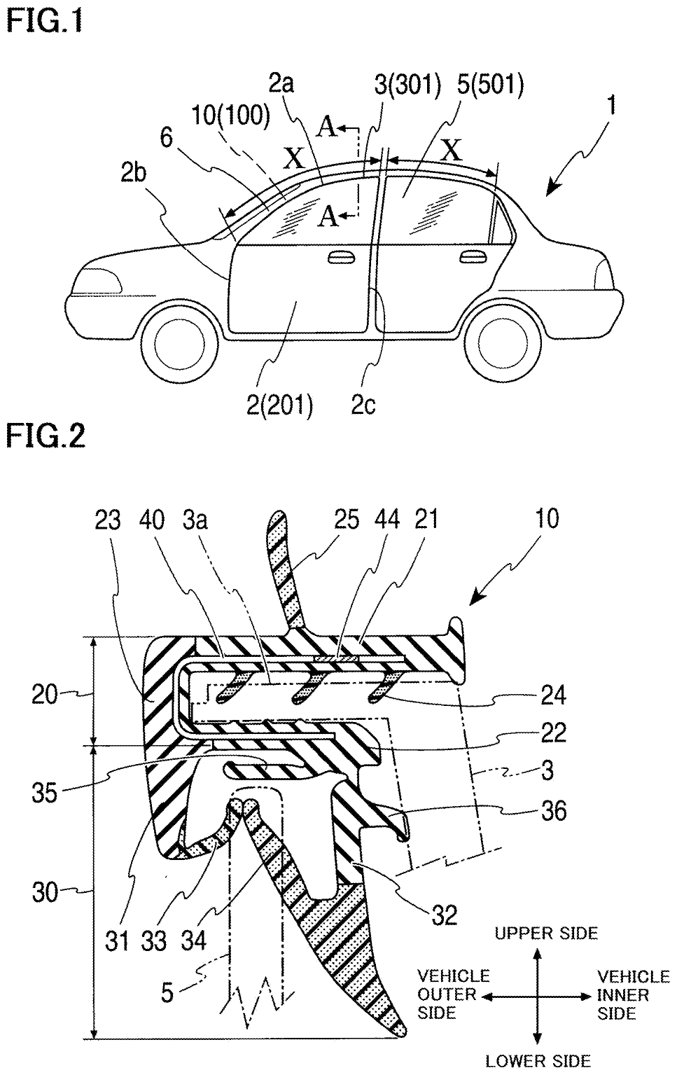

A first embodiment of the present invention will be described with reference to FIGS. 1 to 4. FIG. 1 is a side view of an automobile 1. In an upper portion of a door 2, a door frame 3 is provided at a portion facing a vehicle body opening peripheral edge 6 of the vehicle body, and a door glass 5 is attached so as to be movable up and down. Note that dimensions, shapes, material names, numbers, arrangement methods, and the like described below are examples, and are appropriately changed according to specifications of the glass run and the like.

A glass run 10 is formed in a shape in which a front vertical side portion 2b and a rear vertical side portion 2c of the door 2 in a vehicle front-rear direction and an upper side portion 2a along the roof shape of the door 2 are connected, is attached to an inner periphery of the door frame 3, guides raising and lowering of the door glass 5, and seals a space between the door glass 5 and the door frame 3. In the glass run 10, portions corresponding to the front vertical side portion 2b and the rear vertical side portion 2c of the door 2 in the vehicle front-rear direction and the upper side portion 2a along the roof shape of the door 2 are manufactured by extrusion molding and cut to a predetermined size. Then, the upper side portion 2a and the front vertical side portion 2b, and the upper side portion 2a and the rear vertical side portion 2c are respectively connected by die molding.

Note that a portion of the glass run 10 corresponding to the upper side portion 2a along the roof shape of the door 2 is bent so as to follow the roof shape of the door 2. The present invention relates to a region X in FIG. 1 corresponding to the upper side portion 2a of the glass run 10 along the roof shape of the door 2.

FIG. 2 is a cross-sectional view of the glass run 10 in the first embodiment of the present invention, and is a cross-sectional view corresponding to line A-A in FIG. 1.

The glass run 10 includes a trim portion 20 attached to a flange portion 3a of the door frame 3 of the door 2 and a glass run portion 30 that seals a space between the glass run portion and the door glass 5.

The trim portion 20 is formed in a substantially U-shaped cross section (U-shaped in alphabet) from a glass run-side side wall 22, a body-side side wall 21, and a trim portion bottom wall 23 connecting the glass run-side side wall 22 and the body-side side wall 21 to each other.

On the glass run-side side wall 22 of the body-side side wall 21, three locking lips 24 are formed which are curved to protrude toward a vehicle outer side, and elastically contact the flange portion 3a of the door frame 3. On the other hand, a trim portion seal lip 25 that, when the door 2 is closed, elastically contacts the vehicle body opening peripheral edge 6 and seals a space between the vehicle body opening peripheral edge 6 and the door frame 3 is formed at one position above the body-side side wall 21.

An insert 40, which is a metal reinforcing member for enhancing a holding force with respect to the flange portion 3a of the door frame 3, is embedded in the trim portion 20. The insert 40 will be described in detail below.

On the other hand, the glass run portion 30 includes a vehicle outer side wall 31 located on a vehicle outer side and formed continuously downward from the trim portion bottom wall 23 and the glass run-side side wall 22 of the trim portion 20, a vehicle inner side wall 32 located on a vehicle inner side and formed continuously downward from a vehicle inner end of the glass run-side side wall 22, an outer seal lip 33 formed to be curved toward a vehicle inner side and obliquely upward from a distal end of the vehicle outer side wall 31, and an inner seal lip 34 formed to be curved toward the vehicle outer side and obliquely upward from a distal end of the vehicle inner side wall 32. In addition, the glass run portion 30 is formed larger on the vehicle inner side than on the vehicle outer side, and is formed asymmetrically with respect to the door glass 5.

A bottom wall lip 35 extending from the vehicle inner side wall 32 of the glass run portion 30 to the vehicle outer side is formed below the glass run-side side wall 22 of the trim portion 20. The bottom wall lip 35 can absorb an impact on the glass run-side side wall 22 when an upper end of the door glass 5 abuts on the bottom wall lip 35 when the door glass 5 rises.

A glass run-side locking lip 36 to be locked to the door frame 3 is formed on a vehicle inner side of the vehicle inner side wall 32 of the glass run-side side wall 22.

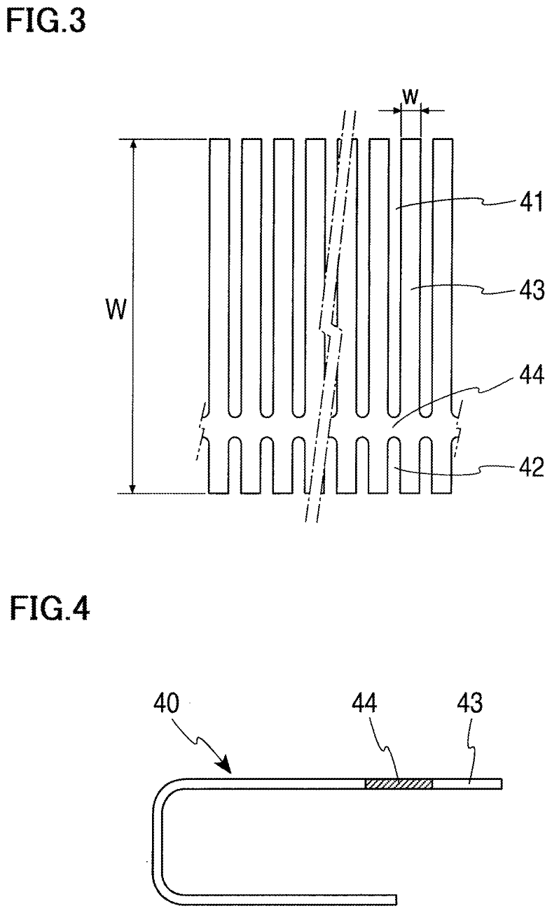

Next, the insert 40 will be described with reference to FIGS. 2 to 4. FIG. 3 is an enlarged plan view of the insert 40 before bending. The insert 40 is made of metal such as stainless steel or aluminum. As illustrated in FIG. 3, the insert 40 has long slits 41 and short slits 42 formed by punching a rectangular band-shaped metal plate, and has a shape in which a plurality of strip-like skeletal pieces 43 formed by the long slits 41 and the short slits 42 which are disposed substantially parallel to each other are connected by connecting portions 44. In the first embodiment, a thin steel plate (SCP, Pickers hardness of 115 to 220) was used as the insert 40.

In FIG. 3, a plate thickness of the insert 40 is 0.5 mm, a width W is 35 mm, a width w of each skeletal pieces 43 is 2 mm, and a length of each connecting portions 44, that is, a slit width is 2 mm.

FIG. 4 is a cross-sectional view of the insert 40 after bending, and FIG. 2 is a cross-sectional view of the glass run 10 in which the insert 40 of FIG. 4 is embedded. As is apparent from FIG. 2, the connecting portions 44 of the insert 40 are embedded in the body-side side wall 21 of the trim portion 20 of the glass run 10. On the other hand, the connecting portions 44 exist in neither the trim portion bottom wall 23 nor the glass run-side side wall 22.

As a result, by bringing the connecting portions 44 close to an inside of the body-side side wall 21, the connecting portions 44 serve as a neutral axis, and the glass run-side side wall 22 in which the connecting portions 44 are not formed on the opposite side across the flange portion 3a of the door frame 3 contracts and can follow a shape of a vehicle door roof, so that it is not necessary to perform special bending modification on the trim portion 20.

In the glass run 10, materials used for other than the insert 40 are as follows.

The body-side side wall 21 and the glass run-side side wall 22 of the trim portion 20 were formed of dynamically cross-linked thermoplastic elastomer (TPV) having a Shore A hardness of 65 to 85. The trim portion bottom wall 23 was formed of polypropylene (PP) that is a thermoplastic resin having a Rockwell hardness of 80 to 100, while the vehicle interior side beyond the insert 40 interposed therebetween was formed of the TPV having a Shore A hardness of 65 to 85.

The trim portion seal lip 25 and the locking lips 24 were formed of the TPV having a Shore A hardness of 60 to 80. The hardness of the trim portion seal lip 25 and the locking lips 24 is smaller than the hardness of the body-side side wall 21 and the glass run-side side wall 22.

The vehicle outer side wall 31 of the glass run portion 30 was formed of PP having the same Rockwell hardness of 80 to 100 as that of the trim portion bottom wall 23 of the trim portion 20. The vehicle inner side wall 32 was formed of the TPV having the same Shore A hardness of 65 to 85 as that of the glass run-side side wall 22 of the trim portion 20.

The outer seal lip 33 and the inner seal lip 34 were formed of the TPV having a Shore A hardness of 60 to 80. The hardness of the outer seal lip 33 and the inner seal lip 34 is smaller than the hardness of the glass run-side side wall 22.

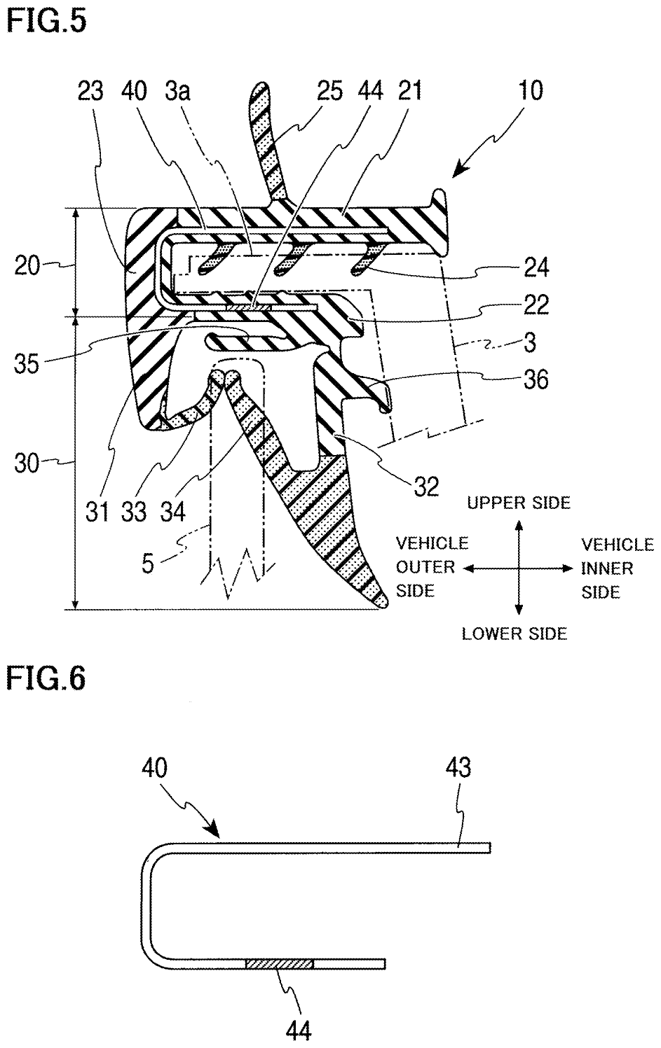

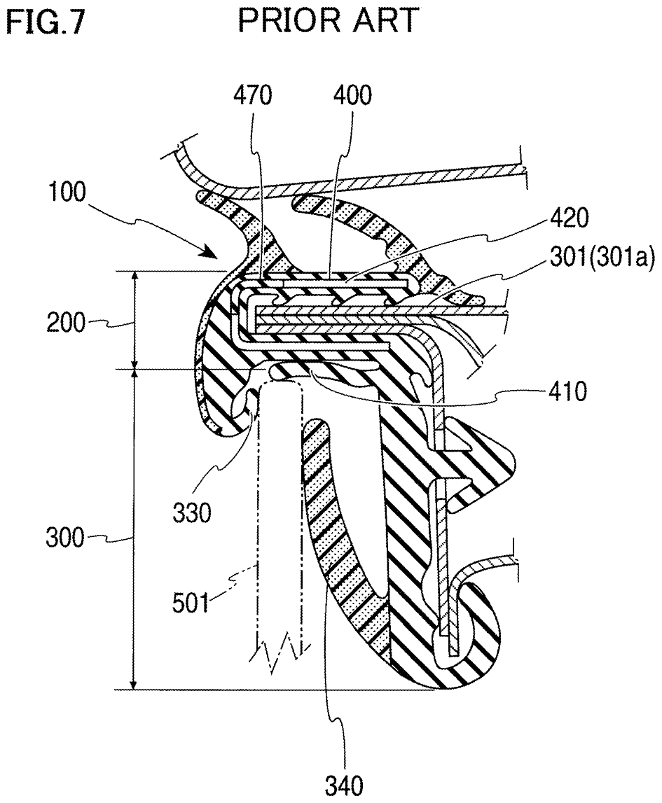

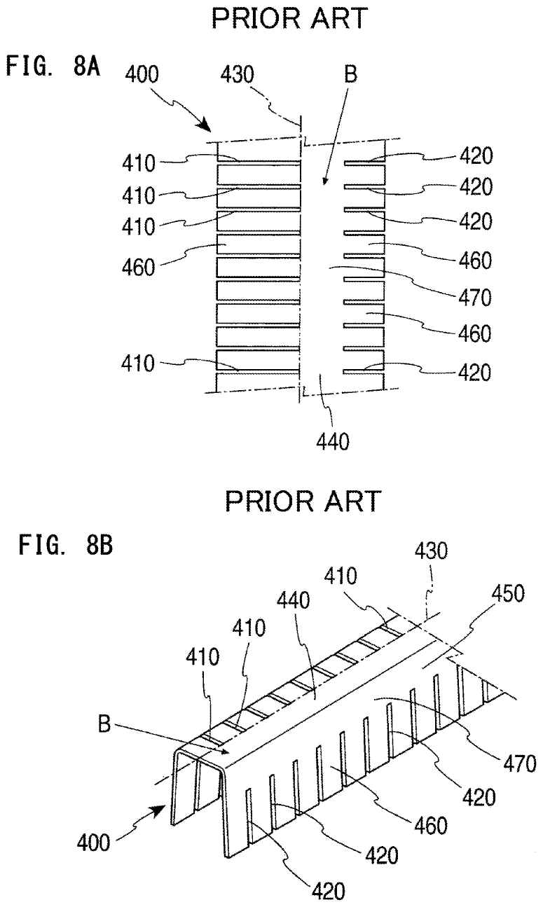

Next, a second embodiment of the present invention will be described with reference to FIGS. 5 and 6. The second embodiment of the present invention is different from the first embodiment described above. In the second embodiment of the present invention, the connecting portions 44 of the insert 40 are embedded in the glass run-side side wall 22 of the trim portion 20 of the glass run 10.

As a result, by bringing the connecting portions 44 closer to the glass run-side side wall 22, the connecting portions 44 serve as a neutral axis, and the body-side side wall 21 in which the connecting portions 44 are not formed on the opposite side across the flange portion 3a of the door frame 3 extends and can follow the shape of the vehicle door roof, so that it is not necessary to perform special bending modification on the trim portion 20. Furthermore, since the length of the connecting portions 44 to be curved becomes shorter than those in a case where the insert is embedded in the body-side side wall 21, followability to the shape of the vehicle door roof is further improved.

The practice of the present invention is not limited to the above embodiment, and various modifications can be made without departing from the object of the present invention.

For example, in the present embodiment, the PP and the TPV were used as materials constituting the glass run 10, but the glass run may be formed of EPDM, a soft synthetic resin, or the like which is a rubber material.

For example, a thin steel plate that is metal was used for the insert 40, but the insert may be formed of a resin material that is harder than a material covering the insert.

What is claimed is:

1. A glass run attached to a door frame of a door of an automobile and sealing a space between the door frame and a door glass, the glass run comprising:
a trim portion attached to a flange portion formed at a distal end of the door frame; and
a glass run portion integrally formed with the trim portion and sealing a space between the glass run portion and the door glass,
wherein the trim portion is formed in a substantially U-shaped cross section from a glass run-side side wall, a body-side side wall, and a trim portion bottom wall connecting the glass run-side side wall and the body-side side wall,
wherein an insert including a plurality of strip-like skeletal pieces arranged in substantially parallel to each other and connecting portions connecting the skeletal pieces is embedded in the trim portion,
wherein the connecting portions of the insert are embedded in either one of the glass run-side side wall and the body-side side wall of the trim portion.

2. The glass run according to claim 1, wherein the connecting portions of the insert are embedded in the glass run-side side wall.
